(19) United States
(12) Patent Application Publication
(10) Pub. No.: US 2026/0281287 A1
(43) Pub. Date: Sep. 17, 2026

(54) DEVICE FOR DISPLAYING ARTIFICIAL SUN-BASED CONTENT

(71) Applicant: LG ELECTRONICS INC., Seoul (KR)

(72) Inventors: Zhimin CHOO, Seoul (KR); Inyoung HWANG, Seoul (KR); Kyoungha LEE, Seoul (KR); Jieun YANG, Seoul (KR)

(73) Assignee: LG ELECTRONICS INC., Seoul (KR)

(21) Appl. No.: 19/167,563

(22) PCT Filed: Mar. 23, 2023
(86) PCT No.: PCT/KR2023/003865

§ 371 Date: Sep. 22, 2025

(51) Int. Cl. H04N 9/31; G06Q 50/12; H04N 9/73; H05B 47/11

(52) U.S. Cl. CPC H04N 9/3155; G06Q 50/12; H04N 9/73; H05B 47/11

(57) ABSTRACT

A device for displaying artificial sun-based content may comprise: a light source driving unit comprising a light source movably arranged in an internal space of a ceiling; a first display arranged on the ceiling and configured to transmit the light source from the light source driving unit; a second display arranged on a wall surface and configured to display an image in which the direction of light is adjusted according to the direction of the light source transmitted through the first display; and a control unit that controls the direction of the light source according to the direction of the light within the image.

### CROSS-REFERENCE TO RELATED APPLICATION(S)

This application is the National Stage filing under 35 U.S.C. 371 of International Application No. PCT/KR2023/003865, filed on Mar. 23, 2023, the contents of which is hereby incorporated by reference herein in its entirety.

### TECHNICAL FIELD

This specification relates to a device and method for displaying artificial sun-based content. More specifically, this specification relates to a device and method for displaying artificial sun-based content within an indoor space.

### BACKGROUND ART

At present, optical technologies such as LEDs and displays are developing significantly. Accordingly, interest is increasing in lighting interiors that provide diverse visual effects using the optical technologies and optical devices rather than simple lighting.

As part of this interest, an artificial sky or artificial sun can be considered that provides a visual effect such as looking at the sky through a real window. The artificial sky or artificial sun can convey to a user the feeling of a real sky by displaying a natural image of the sky with a uniform brightness on part of the ceiling or wall using an LED panel or display.

Meanwhile, in order to generate the artificial sky or artificial sun, a method of installing an LCD or LED display on a part of the ceiling or wall and outputting a natural image such as the sky through the installed display can be used. However, this method uses a display for lighting, and there is a problem in that the brightness is not sufficient as the lighting.

Therefore, an artificial sky or artificial sun can be configured as a separate light source. Meanwhile, the artificial sky or artificial sun needs to be configured to enhance the immersiveness of the user watching content played within a specific space, in addition to its function as simple lighting.

### DISCLOSURE OF INVENTION

### Technical Problem

This specification aims to solve the aforementioned problems and other problems, and aims to enhance the immersiveness of a user viewing content played within a specific space by using artificial lighting that operates as an artificial sun, in addition to its function as simple lighting.

In addition, this specification aims to provide a more vivid light image in conjunction with the content of a display on a wall surface in a specific space through the control of the illuminance of artificial lighting and the direction of light.

In addition, this specification aims to provide a more vivid light image in conjunction with the content of the display on a wall surface in a bathroom through the control of the illuminance of artificial lighting and the direction of light.

In addition, this specification aims to implement an artificial sun control method in conjunction with content played on a display.

In addition, this specification aims to control the illuminance and direction of artificial solar lighting to convert an image according to a time of a display content video and enhance the effect thereof.

In addition, this specification aims to display information necessary for a user during playback of a display content video.

### Solution to Problem

In order to achieve the foregoing or other objectives, a device for displaying artificial sun-based content can include a light source driving unit including a light source movably arranged in an internal space of a ceiling; a first display arranged on the ceiling and configured to transmit the light source from the light source driving unit; a second display arranged on a wall surface and configured to display a video in which a direction of light is adjusted according to a direction of the light source transmitted from the first display; and a control unit that controls the direction of the light source according to the direction of light in the video.

According to an embodiment, the first display can be arranged on a ceiling of a bathroom. The second display can include a first display region arranged on a first wall surface of the bathroom and a second display region arranged on a second wall surface adjacent to the first wall surface. The second display can be implemented as an L-shaped display.

According to an embodiment, the device can further include a reflection surface arranged in an upper region of the light source and configured to reflect light from the light source. A length along one axis of the reflection surface can be configured to be longer than that along one axis of the first display. Light reflected from the reflection surface can pass through the first display to be irradiated to the second display on the wall surface. Light reflected from the reflection surface can pass through the first display to be irradiated to an upper region of the second display.

According to an embodiment, the control unit can control video frames to be sequentially input, and extract the direction and color temperature of light within the video frames. The control unit can control the extracted direction and color temperature of light to be included in a control command that controls the light source.

According to an embodiment, the control unit can control, when an input of the video frames is completed, the direction and color of the light source based on the direction and color temperature of the light included in the control command.

According to an embodiment, the control unit can distinguish a first region where light is irradiated on an object in the video and a second region where light is not irradiated. The control unit can control azimuth and elevation angles of the light source so as to allow the direction of light irradiated to the first region to match the direction of the light source.

According to an embodiment, the control unit can analyze a tone of the video displayed on the wall surface to extract a color temperature value of light. The control unit can adjust a color temperature value of an artificial sun by the light source based on the extracted color temperature value of light.

According to an embodiment, the control unit can control a direction and illuminance of the light source according to a time at which the video displayed on the wall surface was captured and the passage of time.

According to an embodiment, the light source driving unit can be formed to be rotatable in a horizontal direction around one point of the first display. The light source driving unit can include a guide rail formed in a circular shape on an upper or lower surface of the internal space. The light source driving unit can include wheels formed on both sides of the guide rail and a moving device coupled to the wheels and configured to move along a circular path of the guide rail. The light source driving unit can include a horizontal moving unit coupled to the moving device to adjust an azimuth angle through which the light source is transmitted through movement in a horizontal direction.

According to an embodiment, the light source driving unit can be formed to be rotatable in a vertical direction around the one point. The light source driving unit can further include a vertical moving unit coupled to the moving device and the light source to adjust an elevation angle of the light source. The control unit can control, as a direction of light in the video moves in a horizontal direction, the horizontal moving unit to change a horizontal direction of the light source. The control unit can control, as the direction of light in the video moves in a vertical direction, the vertical moving unit to change a vertical direction of the light source.

According to an embodiment, the control unit can determine a first region where light is irradiated to an object in the video and a second region where light is not irradiated over time. The control unit can determine the colors of the first region and the second region over time. The control unit can control the direction and color of the light source for each time and region based on a change in the first region and the second region and a change in the colors over time.

According to an embodiment, a light source region formed on the wall surface by passing through the first display can include a region where the second display is formed and upper and lower regions of the region. The control unit can control a vertical length of the light source region to decrease when the brightness of a background of a video displayed on the second display is below a first threshold. The control unit can control the light source so as to allow the light source region to be formed only in a region where the second display is formed when the brightness of the background of the video is below a second threshold that is lower than the first threshold.

According to an embodiment, the control unit can extract visual information and spatial information of a theme video selected by a user. The control unit can adjust the direction, illuminance, and color of the light source based on the visual information and spatial information.

According to an embodiment, the control unit can control the second display so as to allow the theme video to be displayed. The control unit can control the second display so as to allow icons or screens associated with hotel service notifications, music playbacks, and VOD playbacks to be displayed to overlap the theme video at a time selected by a user.

According to an embodiment, the light source can include a first light source and a second light source irradiated toward the first wall surface and the second wall surface. The control unit can control the direction and color of the first light source based on the direction and color information of light in the video displayed on the first wall surface. The control unit can control the direction and color of the second light source based on the direction and color information of light in the video displayed on the second wall surface.

Specific details of other embodiments are included in the detailed description and drawings.

### Advantageous Effects of Invention

The technical effects of a device for displaying artificial sun-based content according to this specification can be summarized as follows, but are not limited thereto.

According to an embodiment of this specification, artificial lighting that operates as an artificial sun can be used to enhance the immersiveness of a user watching content played within a specific space in addition to its function as simple lighting.

According to an embodiment of this specification, a more vivid light image can be provided in conjunction with the content of a display on a wall surface in a specific space through the control of the illuminance of artificial lighting and the direction of light.

According to an embodiment of this specification, a more vivid light image can be provided in conjunction with the content of a display on a wall surface in a bathroom through the control of the illuminance of artificial lighting and the direction of light.

According to an embodiment of this specification, an artificial sun control method in conjunction with content played on a display by extracting the light direction and color temperature of the content can be implemented.

According to an embodiment of this specification, it can be possible to control the illuminance and direction of artificial solar lighting to convert an image of a display content video according to a time and background such as midday, sunrise, sunset, and glow, and enhance the effect thereof.

According to an embodiment of this specification, an icon and screen associated with a convenience service can be displayed at a desired display position for the user while playing and viewing a display content video.

The effects of this specification are not limited to the above-mentioned effects, and other effects that are not mentioned herein will be clearly understood by those skilled in the art from the description of the claims

### BRIEF DESCRIPTION OF DRAWINGS

FIG. 1 is a block diagram showing a structure of an artificial sky or artificial sun simulation device according to an embodiment of this specification.

FIG. 2 shows a configuration of a device for displaying artificial sun-based content.

FIGS. 3A and 3B show projection regions according to light source positions.

FIG. 3C shows a structure in which light source regions formed by the light sources of FIGS. 3A and 3B include a region in which a first display is arranged.

FIG. 4 shows a light source structure configured to be movable while changing a steering position in horizontal and vertical directions.

FIG. 5 shows a detailed structure of a light source driving unit configured to be movable in a horizontal direction.

FIG. 6 shows a detailed structure of a light source driving unit configured to be movable and rotatable in horizontal and vertical directions.

FIGS. 7A and 7B show light source structures of an artificial sun-based content display device according to this specification.

FIG. 8 shows a flowchart of a light source control method performed in an artificial sun-based content display device according to this specification.

FIG. 9 shows an example video displayed on a display on a wall surface, an image processed video, and an image processed video in which a direction of light is detected.

FIG. 10A shows videos expressed in different colors at different times of the day.

FIG. 10B shows a color temperature table related to FIG. 10A.

FIG. 11 is a drawing showing a region where light is irradiated in a structure in which a light source and a reflection surface are arranged inside a ceiling of a bathroom according to an example.

FIGS. 12A and 12B are drawings showing a region where a video is displayed on a second display and light is irradiated while a user is bathing in a bathtub inside a bathroom of FIG. 11.

FIG. 13 shows screens in which icons or screens associated with hotel service notifications, music playbacks, and VOD playbacks according to embodiments are displayed to overlap a theme video.

### MODE FOR THE INVENTION

It should be noted that technical terms used herein are merely used to describe a specific embodiment, but are not intended to limit the present disclosure. In addition, a singular expression used herein can include a plural expression unless clearly defined otherwise in the context. A suffix “module” or “part” used for elements disclosed in the following description is merely intended for easy description of the specification, and the suffix itself is not intended to have any special meaning or function.

As used herein, terms such as “comprise” or “include” should not be construed to necessarily include all elements or steps described herein, and should be construed not to include some elements or some steps thereof, or should be construed to further include additional elements or steps.

In addition, in describing technologies disclosed herein, when it is determined that a detailed description of known technologies related thereto can unnecessarily obscure the subject matter disclosed herein, the detailed description will be omitted.

In addition, the accompanying drawings are provided only for a better understanding of the embodiments disclosed in this specification and are not intended to limit technical concepts disclosed in this specification, and therefore, it should be understood that the accompanying drawings include all modifications, equivalents and substitutes within the concept and technical scope of the present disclosure. In addition, not only individual embodiments described below but also a combination of the embodiments may, of course, fall within the concept and technical scope of the present disclosure, as modifications, equivalents or substitutes included in the concept and technical scope of the present disclosure.

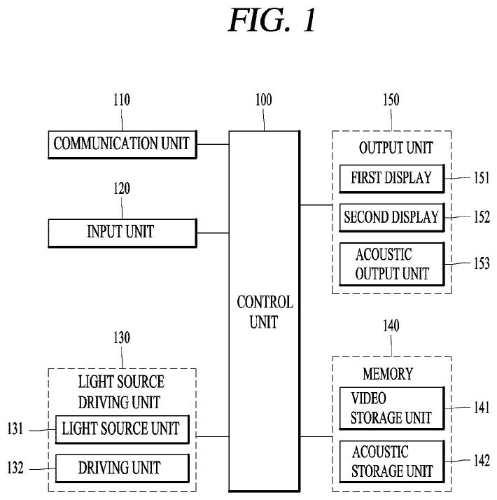

FIG. 1 is a block diagram showing a structure of an artificial sky or artificial sun simulation device according to an embodiment of this specification.

Referring to FIG. 1, an artificial sky or artificial sun simulation device according to an embodiment of the present disclosure can include a control unit 100, a communication unit 110 connected to the control unit 100, an input unit 120, a light source driving unit 130, an output unit 150, and a memory 140. The elements shown in FIG. 1 are not essential for implementing the artificial sky simulation device, and thus the artificial sky simulation device described herein can have more or fewer elements than those listed above.

First, the communication unit 110 can include one or more modules that allows wireless communication between the artificial sky simulation device and a wireless communication system, between the artificial sky simulation device and at least one peripheral device, or between the artificial sky simulation device and an external server. In addition, the communication unit 110 can include one or more modules for connecting the artificial sky simulation device to one or more networks.

The module included in the communication unit 110 can include a wireless Internet module. The wireless Internet module refers to a module for wireless Internet access, which can be built into or external to the artificial sky simulation device. The wireless Internet module can be configured to transmit and receive a wireless signal in a communication network according to wireless Internet technologies.

The wireless Internet technologies can include, for example, wireless LAN (WLAN), wireless-fidelity (Wi-Fi), wireless-fidelity direct (Wi-Fi Direct), digital living network alliance (DLNA), wireless broadband (WiBro), worldwide interoperability for microwave access (WiMAX), high speed downlink packet access (HSDPA), high speed uplink packet access (HSUPA), long term evolution (LTE), long term evolution-advanced (LTE-A), and the like, and can also include Internet technologies not listed above. Furthermore, data can be transmitted and received according to at least one wireless Internet technology in a range not listed above.

Furthermore, the module included in the communication unit 110 can include a short-range communication module. The short-range communication module is configured to facilitate short-range communication, which can support short-range communication using at least one of Bluetooth™, radio frequency identification (RFID), infrared data association (IrDA), ultra wideband (UWB), ZigBee, near field communication (NFC), wireless-fidelity (Wi-Fi), Wi-Fi direct, wireless universal serial bus (wireless USB) technologies, and the like. The short-range communication module can support wireless communication between an artificial sky simulation device and a wireless communication system, and between an artificial sky simulation device and at least one other peripheral device via wireless area networks.

Next, the input unit 120 is configured to input information that is input from a user,
which can include a remote controller including at least one of a mechanical input element, such as at least one button or dome switch, a jog wheel, a jog switch, or the like, and a touch-sensitive input element. The remote controller can be an device implemented exclusively for the artificial sky simulation device, or can be a terminal having an application related to a user input function installed.

In this case, the terminal can include a user's mobile phone, a smart phone, a laptop computer, a personal digital assistant (PDA), a portable multimedia player (PMP), a navigation, a slate PC, a tablet PC, an ultrabook, a wearable device (e.g., smartwatch, smart glasses, head mounted display (HMD)), or the like.

In this case, the terminal can receive an input from a user operating the terminal as an input to the artificial sky simulation device through an application related to a user input function. Furthermore, the received user input can be transmitted to the control unit 100, thereby operating the artificial sky simulation device according to the user input.

Furthermore, the light source driving unit 130 can be formed to include a light source unit 131 and a driving unit 132 formed to move a position of the light source unit 131. The light source unit 131 can be a light source capable of emitting light above a predetermined level when power is applied thereto, and can be directional lighting having a radiation angle within a preset level. As an example, the light source can be concentrated LED lighting having a radiation angle of 30 to 60 degrees.

Additionally, the driving unit 132 may include a mechanism formed to move the light source unit 131 in one direction. For example, the driving unit 132 can be formed to include a rail extending in the one direction, a mount formed to mount the light source unit 131, at least one wheel to move the mount in the one direction on the rail, and a drive motor. In addition, the driving unit 132 can be formed to include a support unit that can support the light source unit 131, so as to prevent shaking of the light source unit 131 mounted on the mount even when the light source unit 131 moves.

Meanwhile, the light source driving unit 130 can be arranged so as to allow the light to be irradiated to a rear surface of a first display 151. As an example, the light source driving unit 130 can be arranged a position facing a rear surface of the first display 151 or arranged so as to face a reflective mirror facing the rear surface of the first display 151.

Here, the reflective mirror can be arranged to face the rear surface of the first display 151 so as to further extend a light reaching distance at which light emitted from the light source unit 131 reaches the rear surface of the first display 151. In this case, the light emitted from the light source unit 131 can be totally reflected by the reflective mirror and irradiated to the rear surface of the first display 151.

Meanwhile, the output unit 150 can include a first display 151 through which light is transmitted, a second display 152 for displaying video information, and an acoustic output unit 155 for outputting acoustic information. Here, the first display 151 can be a transparent display device having a predetermined level of light transmittance or higher so as to allow light from the light source unit 131 to be transmitted therethrough. As an example, the first display 151 can be a transparent LCD display, and can preferably be implemented as a TOLED. Therefore, the light from the light source unit 131 can transmit through the first display 151.

Then, the transmitted light passing through the first display 151 can be irradiated through a front surface of the second display 152. In this case, when a video object output from the second display 152 has a shape, such as a cloud, tree, or leaf, the transmission of the light can be limited, thereby causing a shadow to be formed. In addition, a shadow by the window can be formed. Thus, a shadow from a window, or a shadow formed by a tree, cloud, or leaf, can be formed, and transmitted light similar to sunlight that is actually transmitted through a window can be simulated.

In the following description, for convenience of explanation, it is assumed that the first display 151 is implemented as a TOLED, which is a transparent display. However, this specification is, of course, not limited to such a structure.

Meanwhile, the second display 152 can output a video of the sky corresponding to a weather condition, a region, a season, a date, or a specific time selected by the user under the control of the control unit 100. In this case, light from the light source unit 131 can transmit through the first display 151 on which a video of the sky is displayed. Accordingly, sunlight transmitted through an atmospheric condition corresponding to the selected weather condition or region, season or date, or specific time can be simulated, and a perspective of the sunlight and a shadow effect caused by transmitted light that is transmitted through the second display 152 can be simulated. That is, an artificial sky that simulates a natural sky corresponding to the selected weather condition or region, season or date, or specific time can be output.

Meanwhile, the acoustic output unit 155 can output an acoustic signal according to the sky video output from the second display 152. For example, when the sky video being output is a video of the morning sky, an acoustic signal such as a chirping sound of a bird can be output. Additionally, when the output sky image is a video of the night sky, an acoustic signal that can be heard in the evening, such as the sound of crickets or grasshoppers, may be output. In addition, when the output sky video is a video of a thunderstorm with rainstorm or thunder or lightning, the sound of rain and the sound of thunder can be output as an acoustic signal. Each of those different sky videos can be preset to correspond to at least one different acoustic signal.

The memory 140 can store various data for the operation of the control unit 100. As an example, the memory 140 can store an application or program and instructions for driving and controlling other components connected to the control unit 100. In addition, data related to a plurality of sky videos to be output through the second display 152 and at least one acoustic signal data corresponding to each sky video can be stored. Hereinafter, a region on the memory 140 where data related to the sky video is stored will be referred to as a video storage unit 141, and a region on the memory 140 where the acoustic signal data is stored will be referred to as an acoustic storage unit 142.

Furthermore, the control unit 100 can control an overall operation of the artificial sky simulation device according to an embodiment of the present disclosure, and control connected elements. For example, the control unit 100 can select at least one of a specific region, a specific season or date, and a specific time based on a user input applied through the input unit 120, and can select any one sky video stored on the video storage unit 141 based on at least one of the selected region, season, date, and time. Alternatively, the user can select any one sky video corresponding to a specific weather condition selected by the user. Furthermore, based on at least one of the selected weather condition or region, season or date, and time, the position of the sun can be calculated, and the driving unit 132 can be controlled to move the light source unit 131 according to the calculated position of the sun. Furthermore, the light source unit 131 can be controlled to emit light according to the color temperature and illuminance determined by at least one of the weather condition, region, season, date, and time. In this case, the light source unit 131 can simulate the sun corresponding to at least one of the selected weather condition, region, season, or date and time.

In addition, when a sky video is selected, the control unit 100 can detect at least one acoustic signal corresponding to the selected sky video from the acoustic storage unit 142. Furthermore, the acoustic output unit 155 can be controlled to output at least one detected acoustic signal while at the same time controlling the second display 152 to output the selected sky video. Accordingly, light from the light source unit 131 can be transmitted through the second display 152, that is, the transparent display device, on which the sky video is output. Furthermore, the transmitted light can be irradiated through the front surface of the second display 152 to perform the function of lighting. In this case, the transmitted light, which is emitted from the light source unit 131, can have a sufficient brightness and amount of light that can be used as lighting.

Furthermore, the control unit 100 may control at least one air conditioning device through the communication unit 110. As an example, the control unit 100 can control the humidifier to change an indoor humidity to a humidity corresponding to at least one of the weather condition, region, season, date, and time selected by the user. In this case, when the humidifier is an aroma humidifier, the aroma humidifier can be controlled to output a specific scent corresponding to the sky video output along with a change in the indoor humidity.

In addition, the control unit 100 can further control an air conditioner or an air cleaner. In this case, the air conditioner or air purifier can replace the humidifier through its humidifying function. Additionally, the air conditioner may change an indoor temperature to a temperature corresponding to at least one of the weather condition, region, season, or date and time selected by the user. In addition, based on the sky video, the control unit 100 can control the air conditioner or air purifier so as to form a wind speed corresponding to the selected sky video. As an example, when the output sky video is a clear sky video or a thunderstorm video, the air conditioner or air purifier can be controlled so as to form wind with a strong wind speed. On the contrary, when the output sky video is a morning sky video or a night sky video, the air conditioner or air purifier can be controlled so as to form wind with a weak wind speed.

Meanwhile, the control unit 100 can calculate a position of the sun corresponding to a region, season or date selected over time. Furthermore, the light source can be moved depending on the calculated position of the sun. Therefore, the artificial sky simulation device according to an embodiment of the present disclosure can simulate a position of the sun moving over time by determining the position of the sun moving over time in a selected region, season, or date, and moving a light source according to the determined position of the sun.

In addition, the sky video output through the second display 152 can be changed depending on the position of the sun being simulated. As an example, when a simulation of an artificial sky in the morning is requested from the user, the second display 152 can output a sky video corresponding to the morning sky on the second display 152, and control a peripheral device so as to form temperature, humidity, and wind speed according to the output sky video (morning sky video). Furthermore, when time passes while the artificial sky is being simulated, the position of the light source can be gradually moved over time to simulate the movement of the sun, and control a peripheral device to gradually change temperature, humidity, and wind speed according to the simulated position of the sun.

That is, when the artificial sky is output in the morning and the output of the artificial sky is maintained until the afternoon, the control unit 100 can gradually change the sky video output from the sky video corresponding to the ‘morning sky’ to the sky video corresponding to the ‘clear sky’ over time.

Meanwhile, the temperature corresponding to the ‘clear sky’ can be higher than that corresponding to the ‘morning sky’. In addition, the humidity corresponding to the ‘clear sky’ can be lower than that corresponding to the ‘morning sky’. In addition, the wind speed corresponding to the ‘clear sky’ can be stronger than that corresponding to the ‘morning sky’. Accordingly, the control unit 100 can gradually increase the temperature (e.g., stop an operation of the air conditioner) or decrease the humidity when the sky video corresponding to the ‘morning sky’ is gradually changed to the sky video corresponding to the ‘clear sky’. In addition, an amount of wind output from the air conditioner or air purifier can be increased.

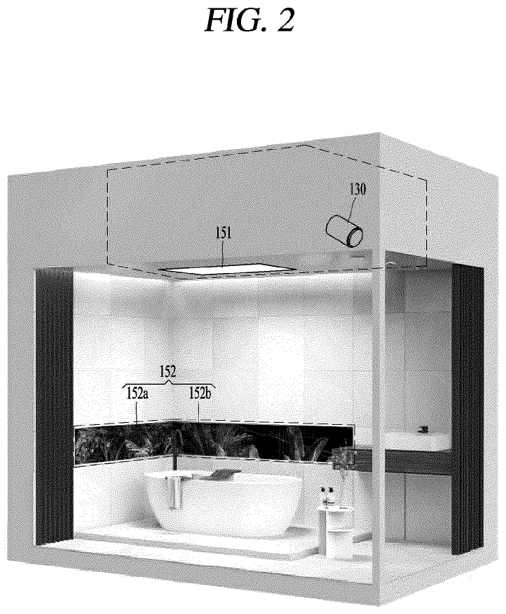

Hereinafter, a device for displaying artificial sun-based content according to this specification will be described. In this regard, FIG. 2 shows a configuration of a device for displaying artificial sun-based content.

Referring to FIGS. 1 and 2, the artificial sun-based content display device can include a light source driving unit 130, a first display 151, a second display 152, and a control unit 100. The artificial sun-based content display device can be implemented in a bathroom, such as in a hotel, but is not limited thereto, and can be any indoor/outdoor space that can play content such as a video.

In a hotel, a view is a very important factor that can affect the room rate, but the view provided is restricted depending on the building's location and the direction of the room. In particular, rooms with sunlight coming in from the ceiling are only available at the top of the building. The artificial sun-based content display device according to this specification can somewhat alleviate a restriction on the region where sunlight enters.

The artificial sun-based content display device according to this specification that can be installed in a bathroom of a hotel or the like can be implemented as the second display 152 which is an L-shaped display on a wall surface near a bathtub. The second display 152 can include a first display region 152a arranged on a first wall surface and a second display region 152b arranged on a second wall surface adjacent to the first wall surface. The light source driving unit 130 arranged inside the ceiling can constitute an artificial sun block located on the ceiling.

The second display 152, which is an L-shaped display, has an external shape similar to an actual window, and thus can provide an immersiveness by making a video displayed on the display feel like an actual outside landscape. The light source driving unit 130, which is an artificial sun block installed on the ceiling, can express a direction of light and a movement of the sun by using light of artificial solar lighting that passes through the first display 151, which is a transparent display such as a TOLED. Specifically, an open sky rather than a closed ceiling can be simulated through a phenomenon of forming on a wall surface, and a direction of light and a movement of the sun can be expressed through the position and movement of light of artificial solar lighting formed on the wall surface.

In this regard, a video of the sky+clouds or the sky+palm leaves, or the like can be displayed on the first display 151, which is a transparent display, to express various places and situations. A direction of light in a video displayed on the second display 152, which is an L-shaped display, can be allowed to match a direction of light felt from the light source unit 131, which is an artificial sun block, by using an integrated system. Accordingly, the user's immersiveness can be increased by making a virtual external landscape more realistic.

The light source driving unit 130 can include a light source 131 that is movably arranged in an internal space of the ceiling. The first display 151 can be arranged on the ceiling. The first display 151 can be configured to transmit a light source from the light source driving unit 130. The first display 151 can be implemented as a transparent display and configured to allow a light source to pass therethrough. The first display 151 can be implemented as a transparent OLED, but is not limited thereto and can be implemented as a display made of any transparent material.

It can be configured to display a video on the second display 152 arranged on a wall surface. The second display 152 can be configured to display a video in which a direction of light is adjusted according to a direction of the light source transmitted from the first display 151. The control unit 100 can control a direction of the light source 131 according to a direction of light in the video. A direction of the light source driving unit 130 can be controlled according to a direction in which light is irradiated on objects in the video to adjust a direction of light in the video on the second display 152 according to a direction of the light source transmitted from the first display 151 According to an embodiment, the artificial sun-based content display device can be implemented in a bathroom of a hotel or the like. The first display 151 can be arranged on the ceiling of the bathroom. The second display 152 can include a first display region 152a arranged on a first wall surface of the bathroom and a second display region 152b arranged on a second wall surface adjacent to the first wall surface. The second display 152 can be implemented as an L-shaped display.

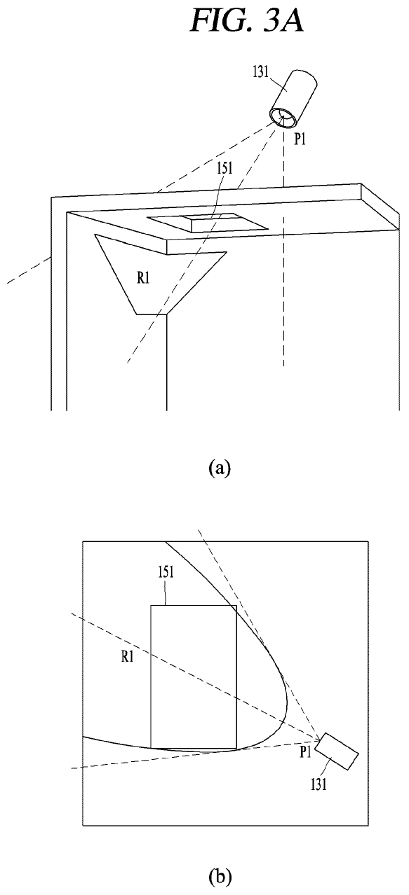

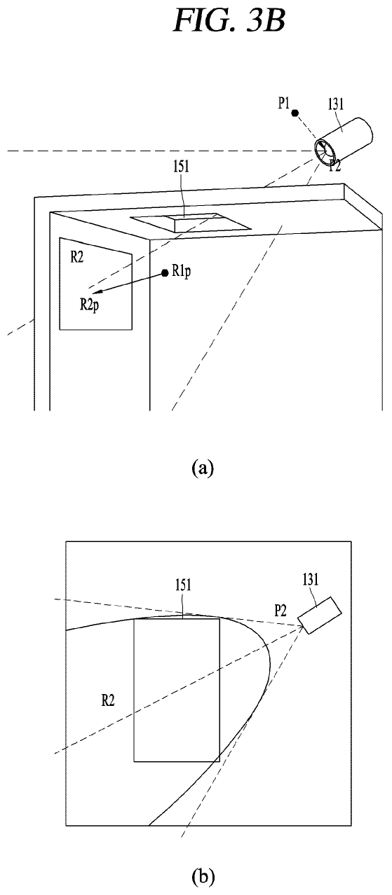

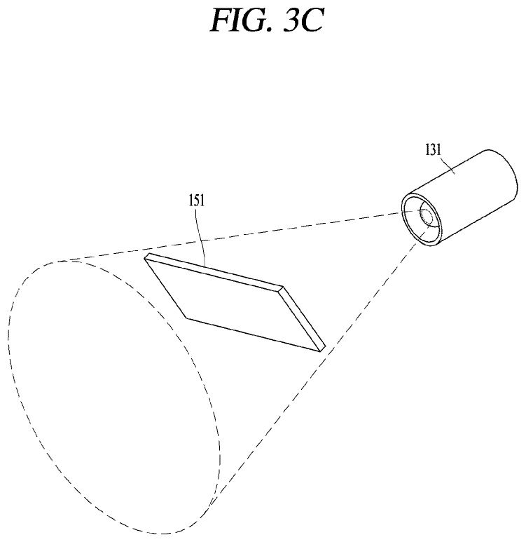

Meanwhile, a device for displaying artificial sun-based content according to this specification can have a projection region that changes in a space such as a bathroom as the position of the lighting or light source corresponding to the artificial sun changes. The movement of the artificial sun can be simulated by moving the projection region, that is, the position of light irradiation. In this regard, FIGS. 3A and 3B show projection regions according to light source positions. Meanwhile, FIG. 3C shows a structure in which light source regions formed by the light sources of FIGS. 3A and 3B include a region in which a first display is arranged.

(a) of FIG. 3A shows a perspective view of a spatial region where a projection region is displayed when the light source 131 is at a first position P1. (b) of FIG. 3A shows a top view of a ceiling in which a light source region passing through the first display 151 is displayed when the light source 131 is at the first position P1.

(a) of FIG. 3B shows a perspective view of a spatial region where the projection region is displayed when the light source 131 is at a second position P2. (b) of FIG. 3B shows a top view of a ceiling in which the light source region passing through the first display 151 is displayed when the light source 131 is at the second position P2.

Referring to FIGS. 1 to 3A, as the light source 131 is arranged at the first position P1, a projection region on the wall surface can be formed in a first region R1. Referring to FIGS. 1 to 3A, as the light source changes from the first position P1 to the second position P2, a projection region on the wall surface can be formed in a second region R2. As the light source changes from the first position P1 to the second position P2, a light irradiation position on the wall surface can change from a first point R1p of the first region R1 to a second point R2p of the second region R2.

Referring to (b) of FIG. 3A, (b) of FIG. 3B, and FIG. 3C, even when a position of the light source 131 is changed, a three-dimensional region of the light source formed by illumination light from the light source 131 can be configured to include a region where the first display 151 made of a transparent material formed on the ceiling is formed as much as possible. Therefore, a movement path and angle of the light source 131 must be adjusted such that a three-dimensional region (e.g., conical region) of the light source 131 includes a region where the first display 151 is formed. When the movement path and angle of the light source 131 are adjusted such that the three-dimensional region of the light source 131 includes the region where the first display 151 is formed, a light irradiation position can be formed within a predetermined region of the wall surface.

Referring to FIGS. 1 to 3, the control unit 100 can be implemented as a processor to control the direction and brightness of light emitted from the light source 131. In addition, the control unit 100 can be implemented as a processor to control the playback of a video displayed on the second display 152 and extract information on the direction and color temperature within a video frame.

The control unit 100 can include a first control unit that controls the direction and brightness of light emitted from the light source 131. The first control unit can be configured as a light source control unit that is arranged inside the ceiling and controls the direction and brightness of light emitted from the light source 131. The control unit 100 can be configured as a video control unit that extracts information on the direction and color temperature of light within a video frame displayed on the second display 152. The light source control unit and the video control unit can transmit information through a wired interface such as a cable or a wireless interface. Therefore, information on the direction and color temperature of light within the video frame can be transmitted to the light source control unit through the video control unit. The light source control unit can control the direction and brightness of light emitted from the light source 131 based on information on the direction and color temperature of light within the video frame.

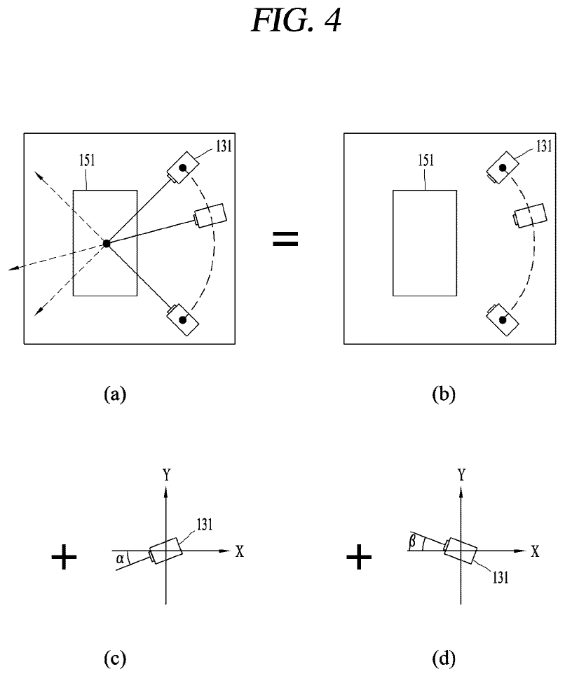

Meanwhile, the light source in a device for displaying artificial sun-based content according to this specification can have its steering position changed in horizontal and vertical directions. In this regard, FIG. 4 shows a light source structure configured to be movable while changing a steering position in horizontal and vertical directions.

Referring to (a) of FIG. 4, the light source 131 can be arranged to be movable and rotatable within a predetermined angular range in a horizontal direction around one point (e.g., a center point) of the first display 151. In this regard, the light source 131, which is an artificial solar lighting, can be controlled to move to change a direction of light according to the movement of the sun. The lighting must be rotated such that the light source 131 corresponding to the lighting faces the first display 151 made of a transparent material, which is a window region of the ceiling in a space.

Referring to (b) of FIG. 4, the light source 131 can move within a predetermined angular range in a horizontal direction around one point (e.g., a center point) of the first display 151. Accordingly, the light source 131 can be operated within a predetermined operating range on the (x, y) coordinates while being arranged in parallel to each center point without being rotated.

Referring to (c) of FIG. 4, the light source 131 can be rotated at a predetermined rotation angle α in a horizontal direction based on the center point of the light source 131. In this regard, the light source 131 can be rotated by a predetermined rotation angle α in a yaw direction on the (x, y) coordinates. Referring to (d) of FIG. 4, the light source 131 can be rotated in a vertical direction at a predetermined rotation angle β based on the center point of the light source 131. In this regard, the light source 131 can be rotated by a rotation angle β in a z-axis direction corresponding to a pitch direction on the x-y plane.

In a device that operates with artificial sun-based lighting, a position and irradiation angle of the light source 131 can be decomposed as follows. The position and irradiation angle of the light source 131 can be decomposed into 1) a position of lighting on the plane (x, y coordinates), 2) a rotation angle α in a yaw direction of the lighting, and 3) a rotation angle β in a pitch direction of the lighting. Accordingly, the light source in a device for displaying artificial sun-based content according to this specification can be implemented with a driving system having four degrees of freedom (DoF).

In a 4-DoF system, two actuators are required to adjust a position of lighting in the XY 2D plane. In addition, the 4-DoF system can be further provided with one actuator for horizontal rotation and one actuator for vertical rotation to adjust an irradiation angle of the lighting. Accordingly, a device operating with artificial sun-based lighting implemented as a 4-DoF system requires a total of four actuators. Meanwhile, from the perspectives of control difficulty and cost and efficiency of the driving system, it is necessary to consider reducing the DoF of the system by linking some of the driving units.

In this specification, a condition in which lighting must be irradiated through the first display 151, which is a window region implemented with a TOLED located on the ceiling of the bathroom, must be satisfied. Therefore, the driving system can be simplified in consideration of such a condition. The movement and rotation angle of the light source 131 can be individually controlled, but the rotation angle according to a position on a movement path of the light source 131 can be integrated and controlled as 1-DoF by a mechanical structure.

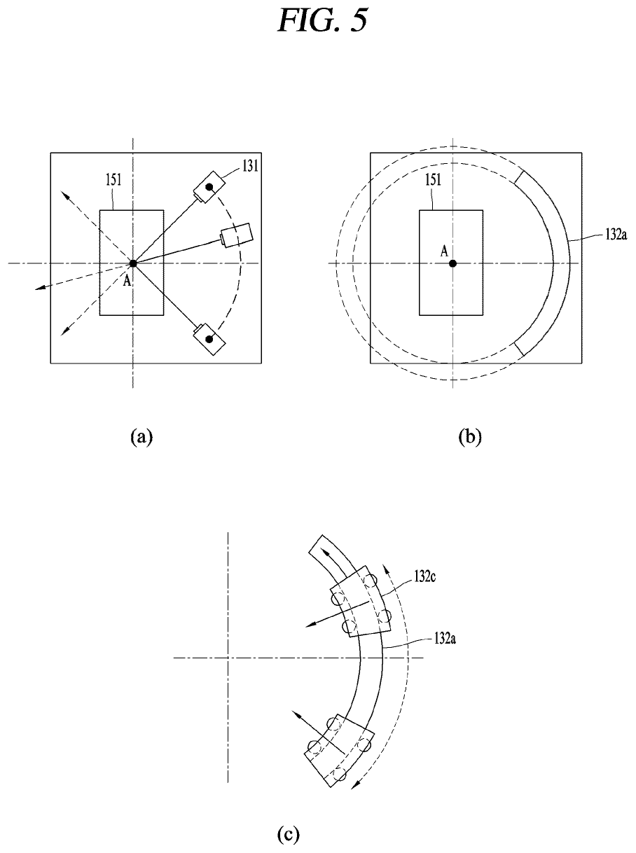

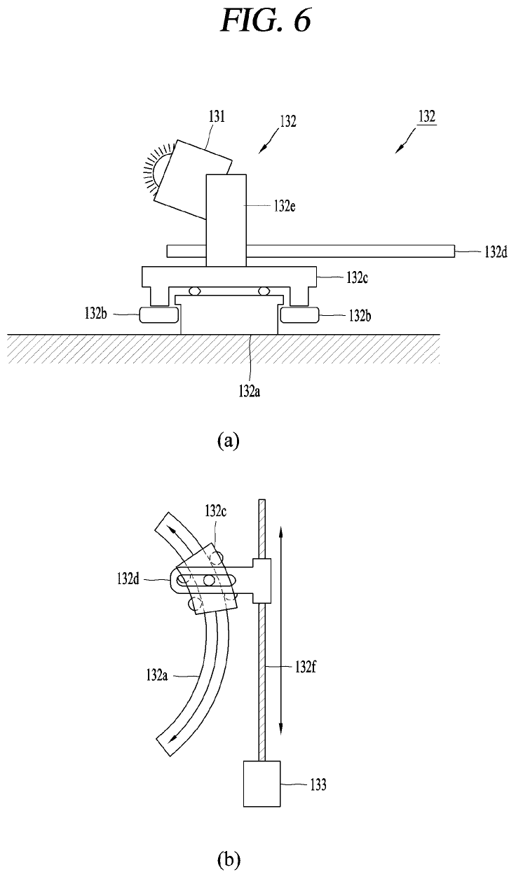

Meanwhile, the light source in a device for displaying artificial sun-based content according to this specification can have its steering position changed in horizontal and vertical directions. In this regard, a light source driving unit of the artificial sun-based content display device can be configured to be movable and rotatable in horizontal and vertical directions. FIG. 5 shows a detailed structure of a light source driving unit configured to be movable in a horizontal direction. FIG. 6 shows a detailed structure of a light source driving unit configured to be movable and rotatable in horizontal and vertical directions.

Compared to the 4-DoF system of FIG. 4, referring to FIGS. 5 and 6, a position and horizontal rotation angle of lighting can be implemented as a 1-DoF system.

A structure that simplifies the system while satisfying a condition of having to irradiate the light source 131 through the first display 151, which is a window region implemented with TOLED located on a ceiling of a bathroom, can be configured as shown in FIGS. 5 and 6. Referring to (a) of FIG. 5, light from a light source 131 needs to be irradiated to a center position (or its vicinity) of the first display 151, and an optical axis needs to be formed based on the center position. Referring to (b) of FIG. 5, a guide rail 132a (or slot) having a concentric circle at the center position (A) can be implemented to control the position and horizontal rotation angle of the light source 131 by 1-DoF. Referring to (c) of FIG. 5, a moving device 132c can be installed on the guide rail 132a. Even when the moving device 132c moves along the guide rail 132a, the moving device 132c always faces the center as shown in (a) of FIG. 5 and (c) of FIG. 5.

Referring to FIG. 5 and (a) of FIG. 6, when the light source 131 is installed in the moving device 132c, a horizontal direction viewed by the light source 131 always faces a center point A. A distance from the center point A to the moving device 132c is constant. Therefore, even when the moving device 132c is fixed in a vertical direction without vertical rotation of the moving device 132c, an optical axis passes through the center point A.

Referring to (b) of FIG. 6, the moving device 132c moving along the guide rail 132a has 1-DoF and thus can be controlled by one actuator 133 in one axis direction. The moving device 132c can be coupled through a coupling unit 132f coupled to a horizontal moving unit 132d. The moving device 132c can be coupled through a slot formed in the horizontal moving unit 132d. The actuator 133 can control the horizontal moving unit 132d coupled to the coupling unit 132f to move on the guide rail 132a, thereby allowing the moving device 132c to move on the guide rail 132a.

Referring to FIGS. 1 to 6, the light source driving unit 130 can be formed to be rotatable in a horizontal direction around one point (e.g., a center point) of the first display 151. The light source driving unit 130 formed to be rotatable in a horizontal direction can be formed in a guide rail structure. The light source driving unit 130 can include a light source 131 and a driving unit 132.

The driving unit 132 can include a guide rail 132a, wheels 132b, a moving device 132c, and a horizontal moving unit 132d. The guide rail 132a can be formed in a circular shape on an upper or lower surface of the internal space of the ceiling. The wheels 132b are formed on both sides of the guide rail 132a to allow the moving device 132c to move on the guide rail 132a. The moving device 132c can be coupled to the wheels 132b and configured to move along a circular path of the guide rail 132a.

The horizontal moving unit 132d can be coupled to the moving device 132c to adjust an azimuth angle at which the light source is transmitted through the first display 151 through horizontal movement. The horizontal moving unit 132d can control a horizontal angle at which the light source is irradiated by adjusting the azimuth angle α on the x-y plane.

The light source driving unit 130 can be formed to be rotatable in a vertical direction around one point (e.g., a center point) of the first display 151. As described above, the light source driving unit 130 can include a light source 131 and a driving unit 132.

The driving unit 132 can further include a vertical moving unit 132e coupled to the moving device 132c and the light source 131 to adjust an elevation angle of the light source 131. The vertical moving unit 132e can control a vertical angle at which the light source is irradiated by adjusting the elevation angle β along the z-axis.

The control unit 1000 can control a horizontal azimuth angle and a vertical elevation angle of the light source 131. The control unit 1000 can control the horizontal moving unit 132d to change a horizontal direction of the light source 131 as a direction of light in a video moves in the horizontal direction. The control unit 1000 can control the vertical moving unit 132e to change a vertical direction of the light source 131 as a direction of light in a video moves in the vertical direction.

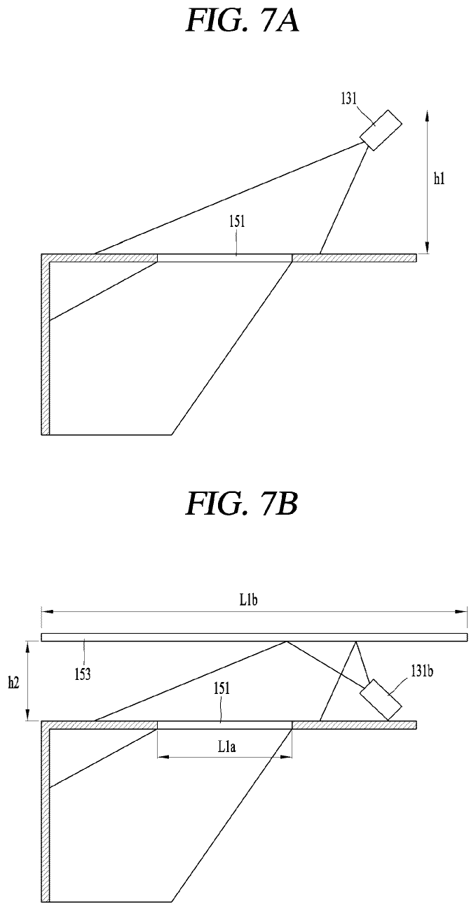

Meanwhile, the light source of the artificial sun-based content display device according to this specification can be implemented with a reflection structure. In this regard, FIGS. 7A and 7B show light source structures of an artificial sun-based content display device according to this specification.

Referring to a first light source structure in FIG. 7A, the light source 131 can be arranged to be spaced apart by a first height h1 from a lower surface of a ceiling where the first display 151 is formed. In the first light source structure, light from the light source 131 spaced apart by the first height h1 from the lower surface of the ceiling can be configured to transmit through the first display 151 so as to be irradiated to a specific region in a space. Referring to FIG. 2 and FIG. 7A, it can be configured to be irradiated to the second display 152 on a wall surface on which a video is displayed and an upper region of the second display 152.

Referring to a second light source structure in FIG. 7B, it is necessary to reduce a space occupied by the light source structure, which is an artificial sun block, while maintaining an operating principle of the artificial sun. To this end, a reflection surface 153 can be arranged in a space where the light source 131, which is artificial solar lighting, is arranged. In this regard, a light source 131b of FIG. 7B can be arranged at a position symmetrical with respect to a position where the light source 131 of FIG. 7A is arranged and the reflection surface 153.

Referring to FIG. 7B, the light source 131b can be arranged on a lower surface of the ceiling where the first display 151 is formed. The reflection surface 153 can be arranged to be spaced by a second height h2 from the lower surface of the ceiling. The second height h2 of FIG. 7B is implemented to have a value smaller than the first height h1 of FIG. 7A. Accordingly, the second light source structure in which the reflection surface 153 is arranged has an advantage that can be implemented at a lower height than the first light source structure in which the reflection surface is not arranged.

The reflection surface 153 can be arranged in an upper region of the light source 131b, and configured to reflect light from the light source 131b. A length Llb along one axis of the reflection surface 153 can be configured to be longer than a length Lla along one axis of the first display. Light reflected from the reflection surface 153 can be configured to pass through the first display 151 so as to be irradiated to a specific region in a space. Referring to FIG. 2 and FIG. 7B, it can be configured to be irradiated to the second display 152 on a wall surface on which a video is displayed and an upper region of the second display 152.

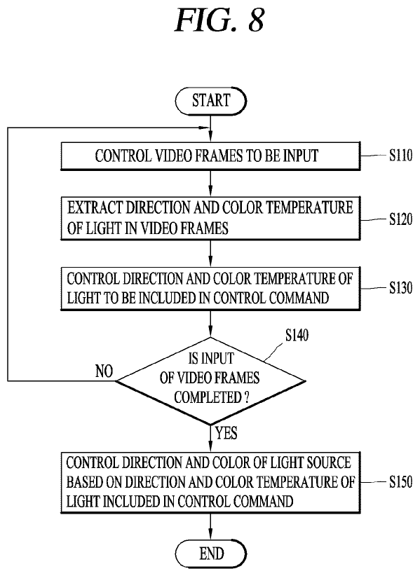

Meanwhile, the artificial sun-based content display device according to this specification can control the light source 131 corresponding to an artificial sun by using the direction and color temperature of light in the video. In this regard, FIG. 8 shows a flowchart of a light source control method performed in an artificial sun-based content display device according to this specification.

Referring to FIGS. 1, 2 and 8, the control unit 100 can control to allow video frames to be input (S110). The control unit 100 can control video frames to be input sequentially or in an order according to a user input/setting. The control unit 100 can extract the direction and color temperature of light in the video frames (S120). The control unit 100 can control the extracted direction and color temperature of light to be included in a control command that controls the light source 131 (S130). In this regard, a write operation can be performed to write information on the direction and color temperature of light to a control table of the light source 131 corresponding to the artificial sun.

The control unit 100 can determine whether an input of video content composed of video frames has been completed (S140). When it is determined that the input of video frames is not completed, the controlling of video frames to be input (S110) is repeatedly performed.

When the input of video frames is completed, the control unit 100 can control the direction and color of the light source 131 based on the direction and color temperature of light included in the control command (S150). In this regard, the control unit 100 can store a control table reflecting information on the direction and color temperature of light and transmit information on the stored control table to a light source control unit that controls the light source 131. Alternatively, the control unit 100 can control the light source 131 based on the control table reflecting information on the direction and color temperature of light.

Therefore, according to an embodiment of this specification, the direction and color temperature of light in a video displayed on an L-shaped display can be extracted and used to control a light source, which is artificial solar lighting, while the video is being played. For the control of the light source, which is artificial solar lighting, a time table for controlling artificial solar lighting can be created in step S130.

By means of the control table derived from a flow chart in FIG. 8, the direction and color temperature of the artificial solar lighting can be controlled to correspond to each video frame for a time-laps video with the movement of the sun. In this regard, the time-lapse video can be implemented as videos in which sunlight moves from a sunrise time point to a glowing time point to illuminate different regions of an object in the video.

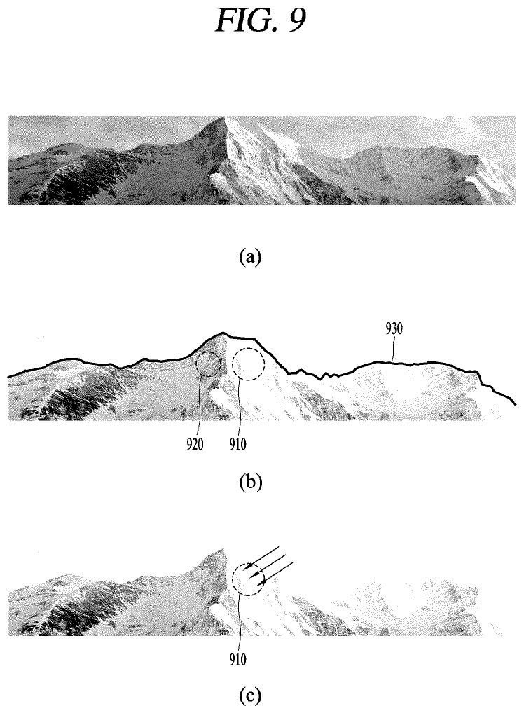

Meanwhile, the artificial sun-based content display device according to this specification can control a light source, which is an artificial sun, based on the direction and color temperature of light in a video. In this regard, FIG. 9 shows an example video displayed on a display on a wall surface, an image processed video, and an image processed video in which a direction of light is detected.

(a) of FIG. 9 shows an example video displayed on a display on a wall surface. (b) of FIG. 9 shows a first region 910 where light is irradiated and a second region 920 where light is not irradiated on an object in the example video in (a) of FIG. 9. Referring to (b) of FIG. 9, a contour 930 corresponding to a boundary between an object and a background displayed in the first region 910 and the second region 920 can be detected. (c) of FIG. 9 shows a direction of light to the first region 910 where light is irradiated on an object in the example video.

Referring to FIGS. 2 and 9, a direction of light in a video displayed on the second display 152 corresponding to an L-shaped display can be determined by human eyes, and accordingly, the movement of a light source, which is an artificial sun, can be controlled. However, through a series of video processing processes, information on an approximate direction of light and color temperature can be extracted. Accordingly, a light source, which is an artificial sun, can also be controlled based on the direction and color temperature of light.

Referring to FIG. 2 and (a) of FIG. 9, the example video in (a) of FIG. 9 can be displayed on the second display 152. Referring to FIG. 1, FIG. 2 and (b) of FIG. 9, the control unit 100 can distinguish a first region 910 where light is irradiated and a second region 920 where light is not irradiated on an object in a video. Referring to FIG. 1, FIG. 2 and (c) of FIG. 9, the control unit 100 can control azimuth and elevation angles of the light source so as to allow a direction of light irradiated to the first region 910 to match a direction of the light source 131.

The direction of light irradiated to the first region 910 can be a predetermined angle in an elevation angle direction toward one region of the video, for example, a right region. However, the direction of light irradiated to the first region 910 is not limited thereto. For example, as time passes from morning to midday, an angle of light can increase as the sun's altitude increases. As time passes from midday to afternoon, an angle of light can decrease as the sun's altitude decreases.

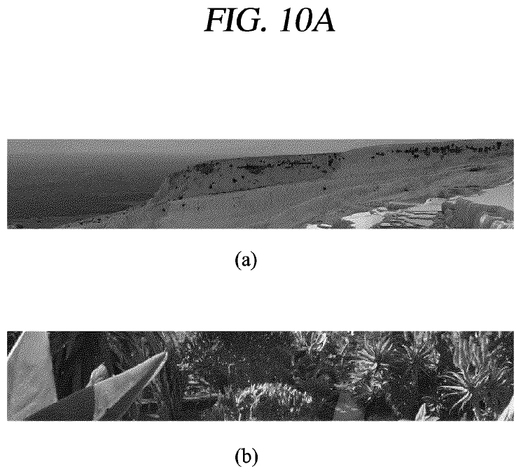

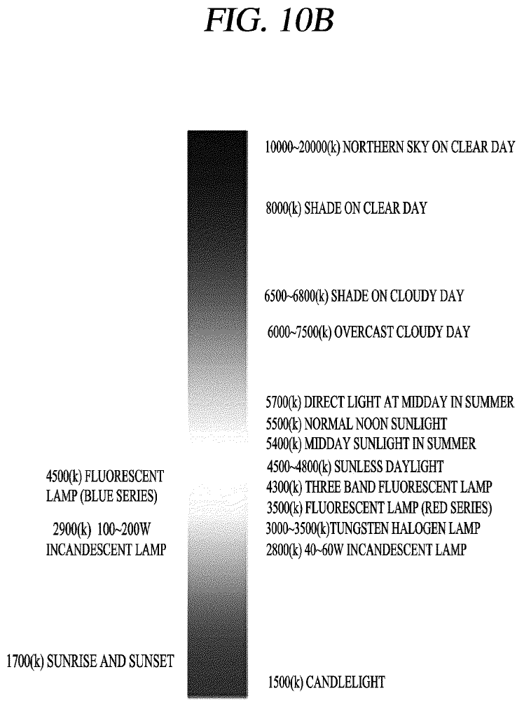

Meanwhile, the artificial sun-based content display device according to this specification can analyze a tone in a video to control artificial solar lighting. In this regard, FIGS. 10A and 10B show a principle of implementing the color of artificial solar lighting by analyzing the tones of example videos. FIG. 10A shows videos expressed in different colors at different times of the day. FIG. 10B shows a color temperature table related to FIG. 10A.

Referring to (a) of FIG. 10A and FIG. 10B, the color temperature of a video expressing sunset glowing sunlight can be expressed as approximately 2000 K. Referring to (b) of FIG. 10A and FIG. 10B, the color temperature of a video expressing midday sunlight can be expressed as approximately 5700 K.

Referring to FIGS. 1, 2, 10A and 10B, a tone in the video can be analyzed to determine whether it is midday sunlight or sunset glowing sunlight, and the color temperature of light can be analyzed to reflect this in the color temperature value of the artificial solar lighting and control it.

The control unit 100 can analyze the tone in the video to control the color temperature value (color) of the light source 131, which is artificial solar lighting. The control unit 100 can analyze a tone of a video displayed on the second display 152 on a wall surface to extract a color temperature value of light. The control unit 100 can adjust the color temperature value of an artificial sun by the light source 131 based on the extracted color temperature value of light.

In addition, the control unit 100 can control the direction and illuminance of the light source according to a time of capture and the passage of time. In this regard, the control unit 100 can control a direction and illuminance of the light source 131 according to a time at which the video displayed on the second display 152 on the wall surface was captured and the passage of time.

Meanwhile, the artificial sun-based content display device according to this specification can control a different illuminance and color to be expressed for each region of an object in a video. Referring to FIGS. 1, 2, 9 to 10B, the control unit 100 can determine a first region 910 where light is irradiated to an object in a video and a second region 920 where light is not irradiated over time.

The control unit 100 can determine the colors of the first region 910 and the second region 920 over time. In addition, the control unit 100 can control the direction and color of the light source 131 for each time and region based on a change in the colors of the first region 910 and the second region 920 over time. In this regard, the first region 910 and the second region 920 can be distinguished differently in a morning including sunrise, midday, and evening including sunset.

The control unit 100 can control the direction, color, and brightness of the light source 131 to change for the first region 910 where light is irradiated over time such as morning, midday, and evening. On the contrary, the control unit 100 can control the brightness of the video to change for the second region 920 where light is not irradiated over time such as morning, midday, and evening. Accordingly, the light source 131 can be controlled in consideration of the direction and color of light of an object in the video based on the first region 910 where light is irradiated, and the brightness of the second region 920 with relatively dark can be partially controlled. Accordingly, only the brightness of a relatively dark region can be adjusted separately while focusing on the user's immersiveness in the region where light is irradiated on the object in the video.

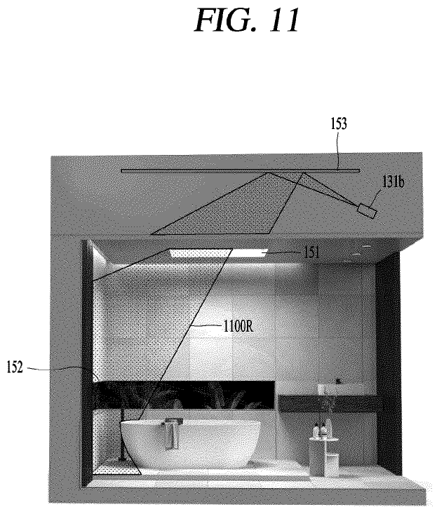

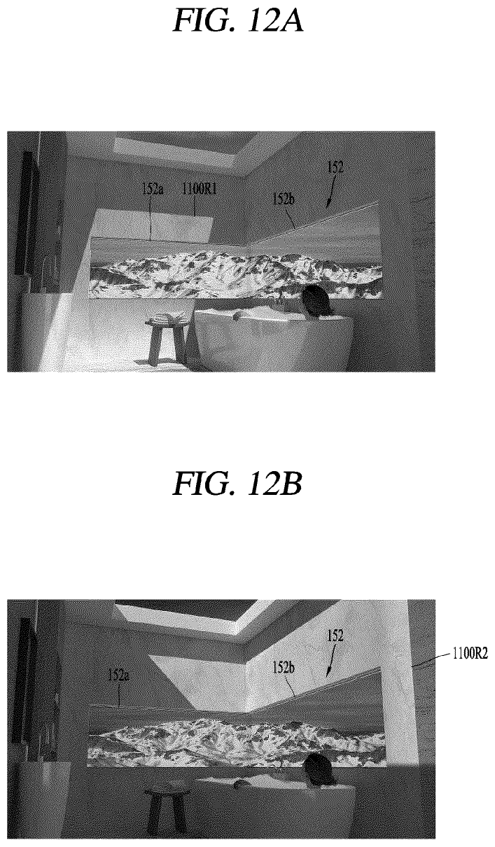

Meanwhile, in the artificial sun-based content display device according to this specification, a region where light is irradiated in a spatial region can be configured to include upper and lower regions in addition to a region of the second display implemented in an L-shape. In this regard, FIG. 11 is a drawing showing a region where light is irradiated in a structure in which a light source and a reflection surface are arranged inside a ceiling of a bathroom according to an example. FIGS. 12A and 12B are drawings showing a region where a video is displayed on a second display and light is irradiated while a user is bathing in a bathtub inside a bathroom of FIG. 11.

Referring to FIG. 11, the light source 131b, which is artificial solar lighting, can be arranged inside a ceiling of a bathroom where an artificial sun-based content display device is implemented, and the reflection surface 132 can be arranged in an upper region of the light source 131. Light irradiated from the light source 131b can be reflected from the reflection surface 132 to pass through the first display 151 arranged on the ceiling of the bathroom to form a light source region 1100R on a wall surface of the bathroom. In this regard, it is not limited to the light source 131b that irradiates upward from a lower region using the reflection surface 132, but can also be implemented as the light source 131 that irradiates downward without the reflection surface as shown in FIG. 7A.

The light source region 1100R can be implemented to include both a region where the second display 152 implemented in an L-shape is formed and upper and lower regions of the region. However, when the brightness of the background of the video displayed on the second display 152 is a dark background below a first threshold, a vertical length of the light source region 1100R can be controlled to decrease to enhance the user's immersiveness. In addition, when the brightness of the background of the video is below a second threshold, which is lower than the first threshold, the light source 131 can be controlled so as to allow the light source region 1100R to be formed only in the region where the second display 152 is formed.

Referring to FIG. 12A, a light source region 1100R1 can be a first display region 152a of a first wall surface corresponding to a front of the user. The light source region 1100R1 can include the first display region 152a and upper and lower regions of the region. Referring to FIG. 12B, over time, a light source region 1100R2 can be a second display region 152b of a second wall surface corresponding to the user's side.

In this regard, the light source 131 can be implemented as one light source or a plurality of light sources. The light source 131 can include a first light source and a second light source irradiated toward the first wall surface and the second wall surface. The control unit 100 can control the direction and color of the first light source based on the direction and color information of light in the video displayed on the first wall surface. The control unit 100 can control the direction and color of the second light source based on the direction and color information of light in the video displayed on the wall surface.

In a structure implemented as one light source 131, the position of the light source 131 can be changed by using the guide rail structure of FIGS. 5 and 6 to irradiate light to the first wall surface or the second wall surface. Accordingly, light of the video displayed in the first and second display regions 152a, 152b can be individually controlled by individually controlling the first light source that irradiates the first wall surface and the second light source that irradiates the second wall surface. Accordingly, when a light source region is formed in the first display region 152a as shown in FIG. 12A, the first light source can be controlled to be on and the second light source can be controlled to be off. On the contrary, when a light source region is formed in the second display region 152b as shown in FIG. 12B, the first light source can be controlled to be off and the second light source can be controlled to be on.

Meanwhile, as the brightness of the background of the video decreases, the light source region 1100R2 can be limited to a region where the second display 152 is arranged or can be formed in an upper region. The light source region 1100R2 can include a second display region 152b and an upper region of the region. The light source region 1100R2 can be formed in an upper region on the side than the light source region 1100R1. Accordingly, the brightness of the artificial solar lighting at the user's gaze position can be configured to decrease as the background brightness of the video decreases.

Referring to FIGS. 12A and 12B, video content displayed on the second display 152 implemented in an L-shape over time can be played, and light irradiated from the light source can move and change color according to the movement of the direction of light in the video. Meanwhile, the video content displayed on the second display 152 can be played according to a time point at which the user enters the bathroom, a time point at which the user enters the bathtub or the user's selection input.

Meanwhile, various theme videos can be displayed on the second display 152 of the artificial sun-based content display device according to this specification. The second display 152, an L-shaped display, which is a device that plays video content, can extract a major color value from video content produced to fit the screen ratio. The major color value can correspond to a color occupying a majority region of the video, but is not limited thereto. For example, the major color value can, when changed from a first video to a second video, be a color newly composed in the second video compared to the first video as well as a color occupying a region above a predetermined area.

Accordingly, it may be configured to be displayed on the corresponding light and the second display 152 that is an L-shaped display and a peripheral region including the same by using the light source unit 131 which is an artificial sun. Meanwhile, an average length of the video played on the second display 152 can be determined in consideration of a time associated with a specific action by the user, such as a bathing time. In an indoor space such as a bathroom, the average length of the video played on the second display 152 can be set to about 20 minutes in consideration of the user's bathing time, but is not limited thereto.

Referring to FIG. 2, FIG. 11 to FIG. 12B, embodiments of theme videos can be displayed as a jungle video, a space video, a city night video, an early evening sky video, a glow landscape video, a spring sky video, and the like.

The jungle video can be configured to express dark light colors and light leaking through the forest according to a change in content. The space video can be composed of blended colors of black and soft purple. The city night video can be composed of soft light and colors that match a dark city background. The early evening sky video can be composed of light and colors leaking from between clouds.

The glow video can be expressed as a first glow video and a second glow video. The first glow video can be composed of a color change in first light, for example, a color change in yellow light over time in the video. The second glow video can be composed of a color change in second light, for example, a color change in purple light over time in the video. The spring sky video is expressed in blue sky color, and the brightness can be adjusted in conjunction with a change in blue color of video content.

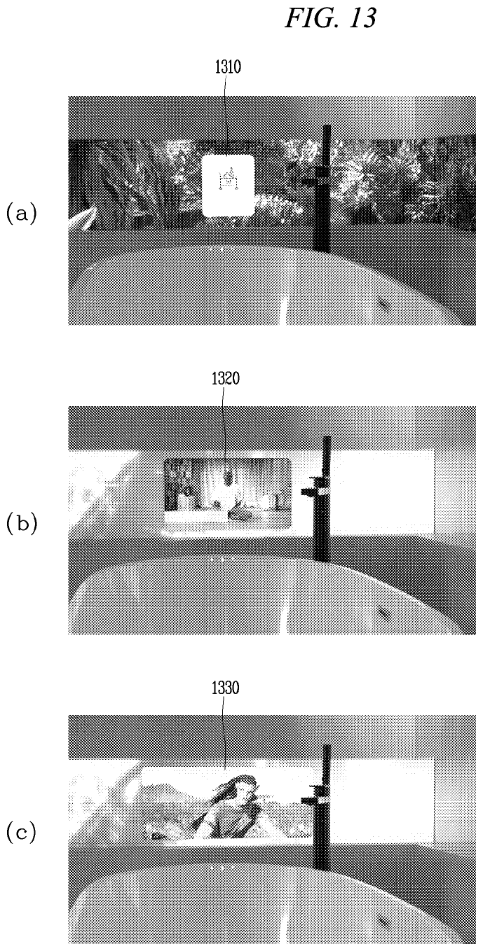

Meanwhile, the artificial sun-based content display device according to this specification can adjust the direction, illuminance, and color of the light source according to the visual and spatial information of a theme video. In addition, the artificial sun-based content display device according to this specification can display icons or screens associated with hotel service notifications, music playbacks, and VOD playbacks to overlap a theme video. In this regard, FIG. 13 shows screens in which icons or screens associated with hotel service notifications, music playbacks, and VOD playbacks according to embodiments are displayed to overlap a theme video.

(a) of FIG. 13 shows a screen configuration in which icons 1310 indicating various hotel service notifications such as a room service are displayed on the second display. (b) of FIG. 13 shows a screen configuration in which a screen 1320 indicating a hotel service notification such as a meditation service is displayed on the second display. (c) of FIG. 13 shows a screen configuration in which a screen 1330 associated with a VOD playback is displayed on the second display.

Referring to FIGS. 1, 2 and 13, the main purpose is to provide a sense of openness and a nice view by giving a metaphor called a window to the second display 152, which is an L-shaped display. However, additional services can be provided by taking advantage of the ability to display information through the second display 152. Accordingly, notification information and the like can be provided in a form of an overlay while playing a video already displayed on the second display 152.

The control unit 100 can extract visual information and spatial information of a theme video selected by the user. The control unit 100 can adjust the direction, illuminance, and color of the light source based on visual information and spatial information.

The control unit 100 can control the second display 152 to display a theme video. The control unit 100 can control the second display 152 so as to allow icons or screens associated with hotel service notifications, music playbacks, and VOD playbacks to be displayed to overlap a theme video at a time selected by the user.

In this regard, the control unit 100 can display information on the first display region 152a of the second display 152 according to a direction of the light source, depending on setting information or a direction of light of an object in a screen or video that the user is watching. Accordingly, the control unit 100 can display an icon 1310 or a screen 1320, 1330 in the first display region 152a.

However, when the direction of light corresponds to the second display region 152b as shown in FIG. 12B, the control unit 100 can display information in the second display region 152b. Accordingly, the control unit 100 can display an icon 1310 or a screen 1320, 1330 in the second display region 152b.

In this regard, the control unit 100 can extract context information a predetermined time period prior to a time selected by the user to determine a display region of the second display 152 corresponding to context information. The context information can be determined based on setting information, a direction of light of an object in a screen and/or video that the user is watching as described above. In addition, the context information can be determined based on information associated with the user's posture and/or gaze.

The control unit 100 can control the second display 152 so as to allow icons 1310 or screens 1320, 1330 associated with hotel service notifications, music playbacks, and VOD playbacks to be displayed in a display region to overlap a theme video at a selected time.

In the above, a device for displaying artificial sun-based content according to this specification has been described. The technical effects of a device for displaying artificial sun-based content according to this specification can be summarized as follows, but are not limited thereto.

According to an embodiment of this specification, artificial lighting that operates as an artificial sun can be used to enhance the immersiveness of a user watching content played within a specific space in addition to its function as simple lighting.

According to an embodiment of this specification, a more vivid light image can be provided in conjunction with the content of a display on a wall surface in a specific space through the control of the illuminance of artificial lighting and the direction of light.

According to an embodiment of this specification, a more vivid light image can be provided in conjunction with the content of a display on a wall surface in a bathroom through the control of the illuminance of artificial lighting and the direction of light.

According to an embodiment of this specification, an artificial sun control method in conjunction with content played on a display by extracting the light direction and color temperature of the content can be implemented.

According to an embodiment of this specification, it can be possible to control the illuminance and direction of artificial solar lighting to convert an image of a display content video according to a time and background such as midday, sunrise, sunset, and glow, and enhance the effect thereof.

According to an embodiment of this specification, an icon and screen associated with a convenience service can be displayed at a desired display position for the user while playing and viewing a display content video.

The effects of this specification are not limited to the above-mentioned effects, and other effects that are not mentioned herein will be clearly understood by those skilled in the art from the description of the claims.

The foregoing present disclosure can be implemented as computer-readable codes on a program-recorded medium. The computer-readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and also include a device implemented in the form of a carrier wave (e.g., transmission over the Internet). In addition, the computer can include the control unit 100 of an artificial sky simulation device according to an embodiment of the present disclosure.

Therefore, the detailed description should not be limitedly construed in all of the aspects, and should be understood to be illustrative. The scope of the present disclosure should be determined by reasonable interpretation of the appended claims, and all changes that come within the equivalent scope of the present disclosure are included in the scope of the present disclosure.

1. A device for displaying artificial sun-based content, the device comprising:
a light source driving unit comprising a light source movably arranged in an internal space of a ceiling;
a first display arranged on the ceiling and configured to transmit the light source from the light source driving unit;
a second display arranged on a wall surface and configured to display a video in which a direction of light is adjusted according to a direction of the light source transmitted from the first display; and
a control unit that controls the direction of the light source according to the direction of light in the video.

2. The device of claim 1, wherein the first display is arranged on a ceiling of a bathroom,
wherein the second display comprises a first display region arranged on a first wall surface of the bathroom and a second display region arranged on a second wall surface adjacent to the first wall surface, and
wherein the second display is implemented as an L-shaped display.

3. The device of claim 1, further comprising:
a reflection surface arranged in an upper region of the light source and configured to reflect light from the light source,
wherein a length along one axis of the reflection surface is configured to be longer than that along one axis of the first display, and
wherein light reflected from the reflection surface passes through the first display to be irradiated to the second display on the wall surface and an upper region of the second display.

4. The device of claim 1, wherein the control unit controls video frames to be sequentially input, extracts the direction and color temperature of light within the video frames, and controls the extracted direction and color temperature of light to be included in a control command that controls the light source.

5. The device of claim 4, wherein the control unit controls, when an input of the video frames is completed, the direction and color of the light source based on the direction and color temperature of the light included in the control command.

6. The device of claim 1, wherein the control unit distinguishes a first region where light is irradiated on an object in the video and a second region where light is not irradiated, and controls azimuth and elevation angles of the light source so as to allow the direction of light irradiated to the first region to match the direction of the light source.

7. The device of claim 1, wherein the control unit analyzes a tone of the video displayed on the wall surface to extract a color temperature value of light, and adjusts a color temperature value of an artificial sun by the light source based on the extracted color temperature value of light.

8. The device of claim 1, wherein the control unit controls a direction and illuminance of the light source according to a time at which the video displayed on the wall surface was captured and the passage of time.

9. The device of claim 1, wherein the light source driving unit is formed to be rotatable in a horizontal direction around one point of the first display, and
wherein the light source driving unit comprises:
a guide rail formed in a circular shape on an upper or lower surface of the internal space;
wheels formed on both sides of the guide rail;
a moving device coupled to the wheels and configured to move along a circular path of the guide rail; and
a horizontal moving unit coupled to the moving device to adjust an azimuth angle through which the light source is transmitted through movement in a horizontal direction.

10. The device of claim 9, wherein the light source driving unit is formed to be rotatable in a vertical direction around the one point,
wherein the light source driving unit further comprises a vertical moving unit coupled to the moving device and the light source to adjust an elevation angle of the light source, and
wherein the control unit controls, as a direction of light in the video moves in a horizontal direction, the horizontal moving unit to change a horizontal direction of the light source, and controls, as the direction of light in the video moves in a vertical direction, the vertical moving unit to change a vertical direction of the light source.

11. The device of claim 1, wherein the control unit determines a first region where light is irradiated to an object in the video and a second region where light is not irradiated over time, determines the colors of the first region and the second region over time, and controls the direction and color of the light source for each time and region based on a change in the first region and the second region and a change in the colors over time.

12. The device of claim 1, wherein a light source region formed on the wall surface by passing through the first display comprises a region where the second display is formed and upper and lower regions of the region, and
wherein the control unit controls a vertical length of the light source region to decrease when the brightness of a background of a video displayed on the second display is below a first threshold, and controls the light source so as to allow the light source region to be formed only in a region where the second display is formed when the brightness of the background of the video is below a second threshold that is lower than the first threshold.

13. The device of claim 1, wherein the control unit extracts visual information and spatial information of a theme video selected by a user, and adjusts the direction, illuminance, and color of the light source based on the visual information and spatial information.

14. The device of claim 11, wherein the control unit controls the second display so as to allow the theme video to be displayed, and controls the second display so as to allow icons or screens associated with hotel service notifications, music playbacks, and VOD playbacks to be displayed to overlap the theme video at a time selected by a user.

15. The device of claim 2, wherein the light source comprises a first light source and a second light source irradiated toward the first wall surface and the second wall surface, and
wherein the control unit controls the direction and color of the first light source based on the direction and color information of light in the video displayed on the first wall surface, and controls the direction and color of the second light source based on the direction and color information of light in the video displayed on the second wall surface.
